(19) United States
(12) Patent Application Publication
(10) Pub. No.: US 2014/0195345 A1
(43) Pub. Date: Jul. 10, 2014

(54) CUSTOMIZING ADVERTISEMENTS TO USERS

(71) Applicant: Philip Scott Lyren, Bangkok (TH)

(72) Inventor: Philip Scott Lyren, Bangkok (TH)

(21) Appl. No.: 13/736,960

(22) Filed: Jan. 9, 2013

(51) Int. Cl. G06Q 30/02

(52) U.S. Cl. CPC G06Q 30/0271
USPC 705/14.53; 705/14.67

(57) ABSTRACT

A computer system analyzes a user profile of a user and determines a product that the user expressed an interest in purchasing. A template video for the product is obtained. This template video is modified to include personal information about the user in order to generate a customized advertisement that is unique to the user. The customized advertisement is presented to the user.

### BACKGROUND

Advertisements can have different purposes, such as selling products or services, informing people about a topic, raising awareness of an issue, and soliciting money or support. Regardless of the purposes, advertisers endeavor to create an advertisement strategy that effectively and efficiently reaches a target audience. Creating such an advertisement strategy poses many challenges to advertisers.

### BRIEF DESCRIPTION OF THE DRAWINGS

FIG. 1 is a computer system in accordance with an example embodiment.

FIG. 2 is a method to select advertisements to present to a user in accordance with an example embodiment.

FIG. 3 is a method to negotiate a price of products and/or services in accordance with an example embodiment.

FIG. 4 is a method to customize advertisements to users in accordance with an example embodiment.

FIG. 5 is a method to adjust customization of advertisements to users in accordance with an example embodiment.

FIG. 6 is a method for a user to participate in building of a customized advertisement for the user in accordance with an example embodiment.

FIG. 7 is a method to select a customized advertisement to display to a user in accordance with an example embodiment.

FIG. 8 shows an electronic device with a screen that displays customized advertisements selectable by a user in accordance with an example embodiment.

FIG. 9 is a method to customize advertisements in accordance with an example embodiment.

FIG. 10 is a method to share customized advertisements with a social network in accordance with an example embodiment.

FIG. 11 is an electronic device with a display screen that displays options with regard to a customized advertisement in accordance with an example embodiment.

FIG. 12 is an electronic device with a display screen that displays information and a customized advertisement in accordance with an example embodiment.

FIG. 13 is a method to provide customized advertisements to a group of people with a common geographical destination in accordance with an example embodiment.

FIG. 14 is a method to generate a customized advertisement from a template video in accordance with an example embodiment.

FIG. 15 is an electronic device in accordance with an example embodiment.

### SUMMARY OF THE INVENTION

One example embodiment is a computer system including a memory that stores instructions and a processing unit that executes the instructions. The processing unit executes the instructions to analyze personal information of a user and to predict a product that the user has an interest to purchase. The processing unit also executes the instructions to obtain a template video that is an advertisement for the product and to present the customized advertisement to the user. The template video includes video footage unique to the user.

### DETAILED DESCRIPTION

Example embodiments include systems, apparatus, and methods that customize advertisements to people. Advertisements to a user are customized from personal information about the user, such as information in a user profile of the user. Content in the advertisement is unique to the user receiving the advertisement since the advertisement includes the personal information.

In example embodiments, users receive customized advertisements that are unique to each of the users. These advertisements can be customized and displayed to a select group of users, such as friends of a user in a social network, or customized and displayed to each single user that receives an advertisement. Each user receives a different and unique advertisement that is specifically designed and/or modified for the user. The advertisement includes content that is unique to the specific user viewing the advertisement.

Consider an example in which Company A launches an advertisement campaign to market a new product B. Each recipient or viewer of the advertisement receives a different advertisement for product B that includes unique material directed to the recipient. This unique material can be obtained from or based on personal information of the user, such as a user profile of the recipient. Each customized advertisement is developed for a single, specific individual and then sent or provided to that specific individual. As such, each individual receives and sees a different advertisement for product B. Advertisements can be unique since they include content that is not provided in the advertisements to other recipients. For example, one customer would not see advertisements to other customers since each customer is provided with a unique advertisement.

Customization of the advertisement includes, but is not limited to, changing, deleting, and/or adding video, images, photographs, and/or audio content in an advertisement. For example, information from a user's profile is inserted into the advertisement or used to alter the advertisement in order to customize the advertisement and make it unique to the user.

In example embodiments, one or more electronic devices build and/or store a user profile of a user. This user profile includes personal information associated with a specific user, such as including characteristics, preferences, and/or habits of the user. An electronic device and/or a user agent then use the user profile to determine what advertisements are displayed to the user and what changes to make to an advertisement in order to customize the advertisement to the user. For example, this electronic device can be a handheld portable electronic device (HPED) owned by the user. The electronic device and/or the user agent can also filter advertisements from being presented to the user if the electronic device and/or user agent determine that the user would not desire to see such an advertisement.

The user agent can be located in the HPED or another device, such as a server in communication with the HPED. Additionally, the electronic device and/or user agent can make requests to merchants for specific product advertisements that are shown to the user of the electronic device. The electronic device and/or user agent thus control which advertisements are displayed to the user, as opposed to the electronic device displaying any advertisements provided from the merchant to the electronic device.

In example embodiments, the electronic device of the user and/or the user agent negotiates on behalf of the user for a price of a product and/or service that the user desires or would like to receive information. For example, the user agent can retrieve or request the price of a product from a merchant and then make a counteroffer for the price. Once the user agent is able to determine a lowest price for the product and/or service, the user agent can present a customized advertisement and the lowest price to the user (e.g., display the customized advertisement to the user on the user's HPED).

After the user agent is able to determine the lowest price for the product and/or service, a template video for the product and/or service is obtained. This template video is then modified into a customized advertisement for the product and/or service. The negotiations between the merchant and the electronic device and/or user agent can occur before the template video is obtained and modified. Alternatively, the template video is obtained while negotiations proceed or before the negotiations commence.

The user can instruct the electronic device and/or user agent to negotiate for a lowest price of a product and/or service. Alternatively, the electronic device and/or user agent can anticipate or predict that the user would like to purchase the product and/or service and negotiate for a lowest price on behalf of the user without first receiving instructions for the particular negotiation. After obtaining a lowest price for the product and/or service, the electronic device and/or user agent can present an advertisement and the lowest price to the user.

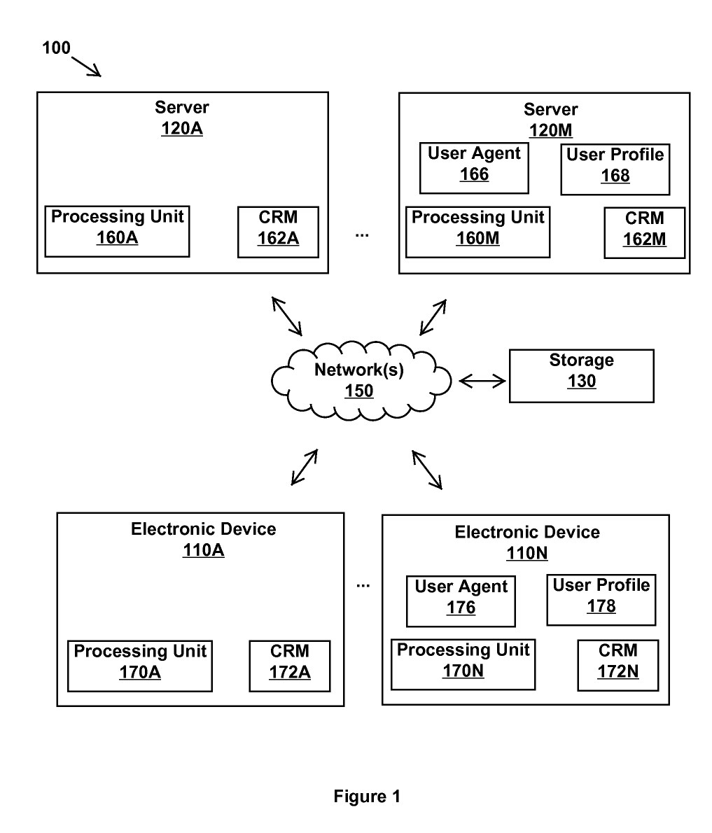

FIG. 1 is a computer system 100 in accordance with an example embodiment. The system includes a plurality of electronic devices 110A to 110N, a plurality of servers 120A to 120M, and storage 130 in communication with each other through one or more networks 150.

The servers 120A to 120M include a processor unit with one or more processors and computer readable medium (CRM), such as random access memory and/or read only memory. Server 120A includes processor unit 160A and CRM 162A, and server 120M includes processor unit 160M and CRM 162M. The processing unit communicates with the CRM to execute operations and tasks that implement or assist in implementing example embodiments. One or more of the servers can also include a user agent and user profile, such server 120M including user agent 166 and user profile 168.

The electronic devices 110A to 110N include a processor unit with one or more processors and computer readable medium (CRM), such as random access memory and/or read only memory. Electronic device 110A includes processor unit 170A and CRM 172A, and electronic device 110N includes processor unit 170N and CRM 172N. The processing unit communicates with the CRM to execute operations and tasks that implement or assist in implementing example embodiments. One or more of the electronic devices can also include a user agent and a user profile, such as electronic device 110A including user agent 176 and user profile 178.

By way of example, the electronic devices 110A to 110N include, but are not limited to, handheld and/or portable computing devices, electronic devices with cellular or mobile phone capabilities, digital cameras, desktop computers, portable computers (such as tablet and notebook computers), handheld audio playing devices (example, handheld devices for downloading and playing music and videos), personal digital assistants (PDAs), combinations of these devices, and other portable and non-portable electronic devices and systems. An example of an electronic device and/or server also appears in FIG. 15.

By way of example, the networks 150 can include one or more of the internet, an intranet, an extranet, a cellular network, a local area network (LAN), a home area network (HAN), metropolitan area network (MAN), a wide area network (WAN), public and private networks, etc.

By way of example, the storage 130 can include various types of storage that include, but are not limited to magnetic storage and optical storage, such as hard disks, magnetic tape, disk cartridges, universal serial bus (USB) flash memory, compact disk read-only memory (CD-ROM), digital video disk read-only memory (DVD-ROM), CD-recordable memory, CD-rewritable memory, photoCD, and web-based storage. Storage can include storage pools that are hosted by third parties, such as an operator of a data center. The electronic devices and/or servers can use the storage to store files, software applications, data objects, etc. Storage can be accessed through a web service application programming interface, a web-based user interface, or other mechanisms.

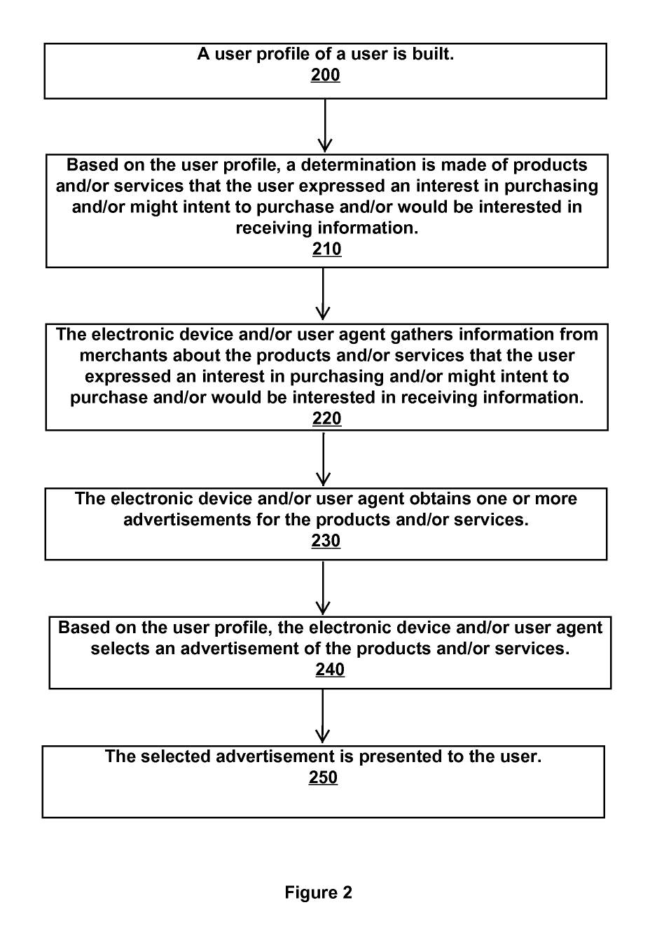

FIG. 2 is a method to select advertisements to present to a user in accordance with an example embodiment.

According to block 200, a user profile of a user is built. In order to build the user profile, one or more electronic devices monitor and collect data with respect to the user and/or electronic devices, such as electronic devices that the user owns and/or interacts. By way of example, this data includes user behavior on an electronic device, installed client hardware, installed client software, locally stored client files, information obtained or generated from a user's interaction with a network (such as web pages on the internet), email, peripheral devices, servers, other electronic devices, programs that are executing, etc. The electronic devices collect user behavior on or with respect to an electronic device (such as the user's computer), information about the user, information about the user's computer, and/or information about the computer's and/or user's interaction with the network.

By way of example, a user profile builder monitors user activities and collects information used to create a user profile. The profile builder monitors the user's interactions with one or more electronic devices, the user's interactions with other software applications executing on electronic devices, activities performed by the user on external or peripheral electronic devices, etc. The profile builder collects both content information and context information for the monitored user activities and then stores this information. By way of further illustration, the content information includes contents of web pages accessed by the user, graphical information, audio/video information, uniform resource locators (URLs) visited, searches or queries performed by the user, items purchased over the internet, advertisements viewed or clicked, information on commercial or financial transactions, videos watched, music played, interactions between the user and a user interface of an electronic device, commands (such as voice and typed commands), hyperlinks clicked or selected, etc.

The user profile builder also gathers and stores information related to the context in which the user performed activities associated with an electronic device. By way of example, such context information includes, but is not limited to, an order in which the user accessed web pages (user's browser navigation), a frequency or number of times a user navigated to a web location, information regarding the user's response to interactive advertisements and solicitations, information about a length of time spent by the user on the web pages, information on the time when the user accessed the web pages, etc.

As previously stated, the user profile builder also collects content and context information associated with the user interactions with various different applications executing on one or more electronic devices. For example, the user profile builder monitors and gathers data on the user's interactions with a web browser, an electronic mail (email) application, a word processor application, a spreadsheet application, a database application, a cloud software application, and/or any other software application executing on an electronic device.

By way of illustration, the user profile builder collects content information for emails that include one or more of the recipient information, sender information, email subject title information, and the information related to the contents of the email including attachments. Context information for an email application may include the time when the user receives emails, time when the user sends emails, subject matter of the emails, frequency of the emails, recipients, etc.

According to block 210, based on the user profile, a determination is made of products and/or services that the user expressed an interest in purchasing and/or might intend to purchase and/or would be interested in receiving information. Information in the user profile is examined to determine one or more products or services that the user may desire and/or may intend to purchase at a current time and/or at a time in the future. An analysis of one or more pieces of information included in the user profile occurs in order to make an intelligent prediction of products and/or services that the user desires to purchase at a current or future time.

As one example, this determination can include keywords extracted from information entered into a handheld portable electronic device (HPED). By way of example, such information includes, but is not limited to, user generated information such as a text, an email, a voicemail, and/or a voice exchange with another person. For instance, a user may state in an email or text certain keywords or phrases that indicate the user desires, needs, wants, and/or intends to purchase a product and/or service (such as “I want . . . ” or “I would like to have . . . ” or “I need . . . ” or “For my birthday . . . ” or “I saw a really nice . . . ” etc). As another example, this determination can include information extracted from a personal electronic device owned by the user. For instance, software and/or hardware on a tablet or personal computer of the user can be out-of-date or new software available, such as new software games or other software the user is interested in purchasing. For instance, the user may be interested in purchasing a new laptop computer, a new smart phone, or a new tablet computer. As yet another example, this determination can include information extracted from a previous purchase of the user. For instance, if the user purchases a vehicle (such as a motorcycle, a car, a boat, etc.), the user may be interested in also purchasing an ancillary product for the vehicle. Alternatively, if the user purchases product X, then the user may also be interested in product Y since other customers that purchased product X also purchased product Y. As yet another example, this determination can include information based on a current, previous, or future physical geographical location of the user. For instance, if the user plans a camping trip to a national forest, the user may be interested in purchasing camping and/or sporting gear. Alternatively, the user may have visited a specific type of store, such as one specializing in particular product and/or service. As yet a further example, this determination can include information from websites that the user visited. For instance, if the user visits a website that sells printers or performs a web query about different printers to purchase, the user may be interested in purchasing a new printer. As yet another example, this determination includes information of the user's prior interest or activity in certain sports, travel destinations, clothes or objects previously purchased, or entertainment preferences. As yet another example, this determination is based on an age of goods or objects that the user owns or previously purchased, such as owning an electronic device that is outdated.

According to block 220, the electronic device and/or user agent gathers information from merchants about the products and/or services that the user expressed an interest in purchasing and/or might intent to purchase and/or would be interested in receiving information. This information about the products and/or services includes, but is not limited to, a price of the products and/or services, a geographical location of the products and/or services, availability of colors/sizes/shapes/etc. of the products and/or services, whether the products are in stock and/or available for immediate shipping or purchasing, promotions and discounts of the products and/or services, shipping times and expenses of the products and/or services, detailed information of the products and/or services (such as technical specifications, warranties, product descriptions, etc.), video (including pictures) of the products and/or services, audio of the products and/or services, comments from other users of the products and/or services, warranties offered for the products and/or services, and written reviews of the products and/or services.

According to block 230, the electronic device and/or user agent obtains one or more advertisements for the products and/or services. For example, the electronic device requests or receives one or more advertisements of the products and/or services from a source, such as a merchant, a vendor, a manufacturer, a server, and/or an electronic device. The electronic device can also participate or assist to generate, to customize, to create, and/or to alter an advertisement of the products and/or services.

According to block 240, based on the user profile, the electronic device and/or user agent selects an advertisement of the products and/or services. If the electronic device and/or user agent obtains multiple different advertisements of the products and/or services, the electronic device and/or user agent uses information in the user profile to determine which advertisement the user would prefer to see or which advertisement would be more effective to market the product and/or service to the user. The electronic device and/or user agent makes an intelligent determination or prediction as to which advertisement the user would prefer to view or which advertisement would more greatly impact the user's decision to purchase the products and/or services. For example, information in the user profile is compared with different advertisements to select one of the advertisements to display to the user.

Information included in the user profile assists in making the determination which advertisement the user would prefer to see. For example, the user profile can include preferences that are obtained from previous advertisements being presented to the user. For instance, a record is maintained of previous advertisements that the user viewed and corollary information about these advertisements. This corollary information includes, but is not limited to, preferred colors, sizes, and/or shapes in advertisements, preferred geographical locations in which the advertisements appear, preferred style of advertisement, such as comical, serious, scary, preferred length of time for advertisements, (e.g., the user prefers or is more responsive to video advertisements that last thirty seconds or less opposed to video advertisements lasting longer than thirty seconds), informative, satirical, celebrity advertisement, etc.), preferred medium for delivering the advertisement (such as radio, television, internet, video, audio billboard, newspaper, magazine, infomercials, local, public service, etc.), whether the advertisement caused the user to purchase the products and/or services, caused the user to obtain more information about the products and/or services, was fully viewed by the user (e.g., did the user view the full advertisement), caused the user to perform an action and/or show further interest in the products and/or services (e.g., caused the user to click an icon or hyperlink, navigate to a website, request more information about the products and/or services, view the products and/or services, etc.).

Other information included in the user profile can also assist in making the determination which advertisement the user would prefer to view. For example, the user may prefer certain geographical locations (such as mountains, beach, desert, jungle, water, land, sky, etc.), prefer certain types of activities (such as sports or a certain leisure activities), or prefer certain affiliations (such as political, religious, scholastic, environmental, etc.).

Information in the user profile can assist in selecting one advertisement from multiple available advertisements. Alternatively, the information can assist in a decision not to select an advertisement to present to the user. For example, a determination is made that none of the available advertisements are appropriate or effective for the user.

According to block 250, the selected advertisement is presented to the user. After the electronic device and/or user agent selects an advertisement for the user, this advertisement is presented and/or provided to the user. For example, the selected advertisement is displayed to the user on a display of an electronic device, stored in memory, and/or transmitted over a network to the user and/or an electronic device.

In the example embodiment of FIG. 2, one or more electronic devices and/or user agents determine, select, and/or control which advertisements are presented to a user. This electronic device could be owned by the user (such as an HPED of the user) and/or an electronic device and/or user agent authorized by the user to make such a determination (such as a server in communication with an electronic device of the user).

The electronic device and/or user agent can request advertisements and then present these advertisements to the user (as opposed to advertisements being presented to the user without first receiving input from the user or an electronic device of the user, such as advertisements automatically playing when a user visits a website). For example, a determination is made that the user would be interested in purchasing a digital camera or acquiring more information about such cameras. An electronic device of the user or a user agent of the user requests advertisements for digital cameras. The advertisements are then compared with information in the user profile to determine which of the advertisements the user would be more interested in viewing (e.g., which advertisement or advertisements are more likely to be effective in providing the user with information about digital cameras). The electronic device and/or user agent selects the advertisement and then provides this selected advertisement to the user. One or more of these advertisements can also be customized and presented to the user as discussed herein.

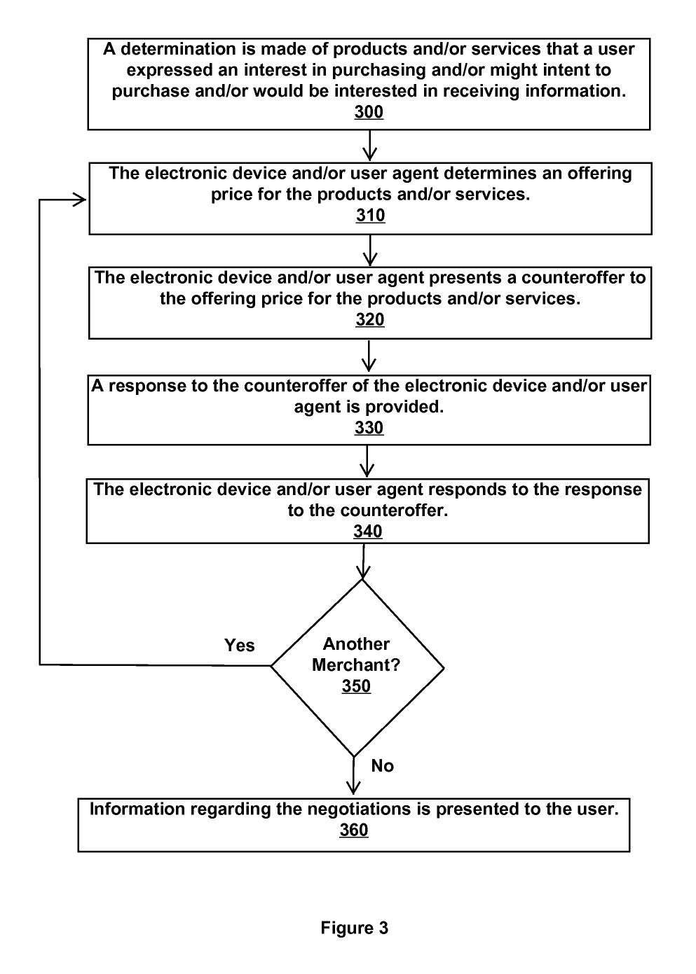

FIG. 3 is a method to negotiate a price for products and/or services in accordance with an example embodiment.

According to block 300, a determination is made of products and/or services that a user expressed an interest in purchasing and/or might intent to purchase and/or would be interested in receiving information. In one embodiment, the user instructs the electronic device and/or user agent which products and/or services are desired. For example, the user instructs the electronic device and/or user agent to negotiate a price for a specific make and model of a new tablet computer. Alternatively, the electronic device and/or user agent determines a product and/or service that the user might need or might desire. For example, this determination is based in part on information included in the user profile. For instance, the electronic device determines from a text or voice exchange between the user and a third party that the user is interested in purchasing a new camera.

After the electronic device and/or user agent determines the product and/or service, the user is notified. For example, an electronic message to the user states that the electronic device will gather more information on a certain product and/or service (such as determining shipping availability, price, location, etc. of the product and/or service). Alternatively, the electronic device can proceed to gather this information without the user being notified.

The determination in accordance with block 300 can also be made in accordance with the discussion of block 210 discussed herein.

According to block 310, the electronic device and/or user agent determines an offering price for the products and/or services. For example, the electronic device and/or user agent contacts the merchant and determines the offering price for the product and/or service. This offering price may be posted or advertised at a public location, such as being available over a network (such as being on a website of the internet), available in a publication (such as a newspaper or magazine), or broadcast (such as being broadcast over radio, television, or other media).

In addition to the offering price, the electronic device and/or user agent can also determine and/or negotiate additional information and/or aspects about the products and/or services. For example, this additional information and/or aspects about the products and/or services includes, but is not limited to, a geographical location of the products and/or services, availability of colors/size/shape/etc. of the products and/or services, promotions and discounts of the products and/or services, shipping times and expenses of the products and/or services, detailed information of the products and/or services (such as technical specifications, warranties, product descriptions, etc.), video (including pictures) of the products and/or services, audio of the products and/or services, comments from other users of the products and/or services, warranties offered for the products and/or services, and written reviews of the products and/or services.

The determination in accordance with block 310 can also be made in accordance with the discussion of block 220 discussed herein.

According to block 320, the electronic device and/or user agent presents a counteroffer to the offering price for the products and/or services. For example, if the product is a printer model ABC being offered for sale of $1000 by merchant XYZ, the electronic device and/or user agent contacts the merchant with a counteroffer such as: “Printer model ABC is being offered for $1000. Would you accept $950 for this printer model ABC?”

The counteroffer can be a definitive counteroffer in which the electronic device and/or user agent is already authorized to negotiate and purchase the product and/or service. For example, the user previously authorized and/or instructed the electronic device and/or user agent to negotiate a price for a specific product. An example of a definitive counteroffer is as follows: “Printer model ABC is being offered fro $1000. I will purchase the printer model ABC for a counteroffer price of $950.” Alternatively, this counteroffer can be a non-definitive counteroffer that determines whether the merchant would be willing to lower price if the user were then to agree to such a lowered price. For example, the user may be interested in purchasing the product if the electronic device and/or user agent can negotiate a price within a certain price range. For instance, the user instructs the electronic device that the user would be interested in purchasing Printer ABC if the electronic device can find this printer and negotiate a price below $951. Alternatively, the electronic device attempts to find the printer with the lowest possible price before presenting the price and/or an advertisement for the printer to the user. An example of a non-definitive counteroffer is as follows: “Printer model ABC is being offered for $1000. Would you accept $950 for this printer model ABC?”

According to block 330, a response to the counteroffer of the electronic device and/or user agent is provided. For example, the merchant responds with one of an acceptance of the counteroffer, a rejection of the counteroffer, or a counteroffer of the counteroffer. An example of an acceptance to the counteroffer is as follows: “Yes, I accept your counteroffer price of $950 for printer model ABC.” An example of a rejection to the counteroffer is as follows: “No, I reject your counteroffer price of $950 for printer model ABC.” An example of a counteroffer is as follows: “I reject your counteroffer price of $950 for printer model ABC, but I will sell printer model ABC to you for $960.”

According to block 340, the electronic device and/or user agent responds to the response to the counteroffer. For example, the response to the merchant depends on what response the merchant provided to the electronic device. The electronic device and/or user agent can end negotiations with the merchant, finalize the price with the merchant, or further negotiate the price with the merchant. For example, if the merchant accepted the definitive counteroffer above, the electronic device could respond as follows: “Yes, we agree to purchase the printer model ABC for $950.” If the merchant accepted the non-definitive counteroffer above, the electronic device could respond as follows: “Thank you for lowering the price of printer model ABC to $950. I will present this price to the user and notify you if the user desires to purchase printer model ABC for $950.”

According to block 350, a determination is made whether another merchant is offering the product and/or service. If the answer to this determination is “yes” then flow proceeds back to block 310. If the answer to this determination is “no” then flow proceeds to block 360.

According to block 360, information regarding the negotiations is presented to the user. Thus, the electronic device and/or user agent negotiate with the merchant (or entity selling the product and/or service) for terms regarding the products and/or services and then present one or more of these negotiated terms to the user. For example, the electronic device presents a negotiated price of the product and/or service to the user.

The information collected during the negotiations with the merchants can be presented or displayed to the user, stored in memory, and/or transmitted to the user. For example, if the merchant accepted the definitive counteroffer above, the user can be provided with the following information: “We agree to purchase printer model ABC for $950 from merchant XYZ.” If the merchant accepted the non-definitive counteroffer above, the user can be provided with the following information: “Merchant XYZ agrees to lower the price of printer model ABC to $950.”

Example embodiments of FIG. 3 include situations in which the user instructs the electronic device and/or user agent of a specific product and/or service and requests the electronic device and/or user agent to negotiate terms such as a price for this specific product and/or service. These embodiments also include situations in which the electronic device and/or user agent determines what products and/or services the user might desire or need, negotiates and/or determines terms for these products and/or services, and then presents the terms for these products and/or services to the user. In this latter situation, the user may not be aware that the electronic device and/or user agent is negotiating for the terms on behalf of the user for a specific product and/or service. For example, the electronic device and/or user agent may have a general authorization to negotiate non-definitive counteroffers for products and/or services that the electronic device and/or user agent determines that the user might desire or need. This general authorization may include products and/or services that the electronic device and/or user agent determines per the user profile that the user desires or needs. Alternatively, this general authorization may include specific categories of products and/or services, such as any electronic devices, or specific types of electronic devices (e.g., tablet computers, cameras, and televisions). As such, the electronic device and/or user agent can contact the merchant and negotiate for a price without the user having knowledge of such negotiations since electronic device and/or user agent is authorized to negotiate on behalf of the user.

In addition to negotiating the offering price, the electronic device and/or user agent can also negotiate various terms and conditions regarding about the products and/or services. For example, the electronic device can negotiate terms and conditions with regard to a geographical location where the products and/or services are shipped or delivered, purchase of colors/sizes/shapes/etc. of the products and/or services, promotions and discounts of the products and/or services, shipping times and expenses of the products and/or services, detailed information of the products and/or services (such as technical specifications, warranties, product descriptions, etc.), discounts for bulk purchases, and warranties offered for the products and/or services. The electronic device and/or user agent can provide the user with one or more of the negotiated aspects.

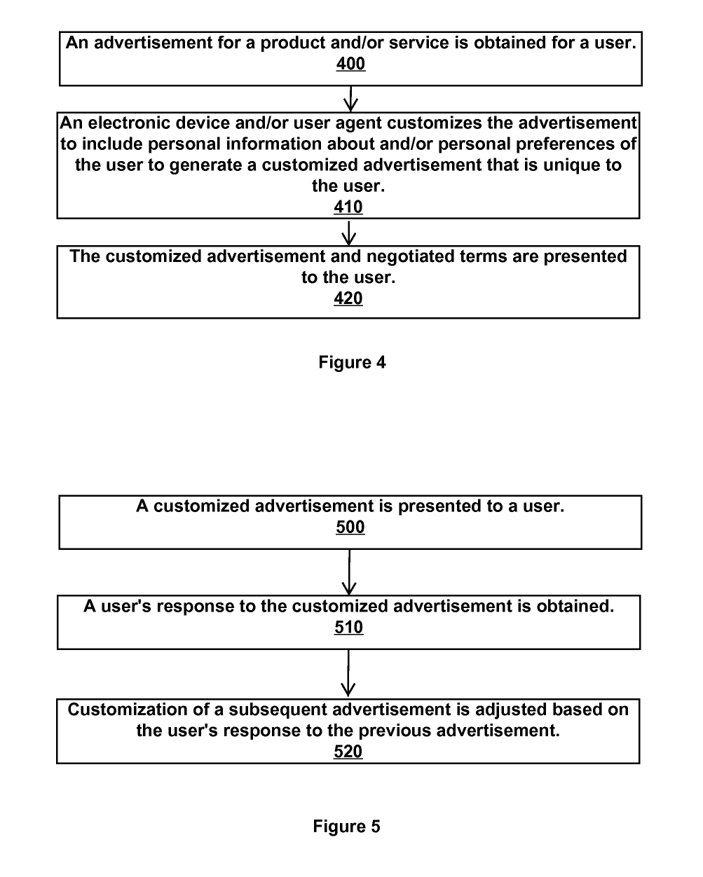

FIG. 4 is a method to customize advertisements to users in accordance with an example embodiment.

According to block 400, an advertisement for a product and/or service is obtained for a user. For example, an electronic device and/or user agent obtains, receives, changes, retrieves, requests, and/or generates the advertisement for the product and/or service.

According to block 410, an electronic device and/or user agent customizes the advertisement to include personal information about and/or personal preferences of the user to generate a customized advertisement that is unique to a user. For example, the electronic device and/or user agent adds, deletes, and/or alters content in the advertisement in order to personalize the advertisement to the user. For instance, the information is obtained from the user profile, and this information is used to edit the advertisement to generate a unique commercial that is intended to be viewed solely by the user.

According to block 420, the customized advertisement and negotiated terms are presented to the user. For example, the customized advertisement is displayed to the user on a display of an electronic device, stored in memory, and/or transmitted over a network to the user and/or an electronic device.

The negotiated terms can be presented to the user before presenting the customized advertisement to the user, simultaneously while presenting the customized advertisement to the user, and/or after presenting the customized advertisement to the user.

Consider an example in which the user agent determines that the user might be interested in purchasing a printer. The user agent locates printer model ABC, negotiates a price of $400 for this printer, and obtains a customized advertisement for this printer. The user agent then provides the user with a notification or message that informs the user about the printer. For instance, a message displays on the user's HPED as follows: “I found printer model ABC for $400.” When the user clicks on the message and/or a hyperlink provided with the message, then the customized advertisement for the printer plays on the user's HPED.

Consider another example in which the user agent determines that the user would like more information about tablet computers. The user agent locates a tablet computer at a store proximate to the user, negotiates a price of $500 for this tablet computer, and obtains a customized advertisement for this tablet computer. This advertisement is customized to include the negotiated price of $500 at the proximate location. The user agent provides the customized advertisement to the user. While the customized advertisement plays on a display of the user's HPED, the information of the price $500 and the location of the tablet computer are revealed to the user in the customized advertisement. For example, the customized advertisement is edited to include this information, such as presenting the price and/or proximate location as spoken words or text in the advertisement. The customized advertisement video presented to the user thus includes the negotiated and/or discovered information obtained by the user agent.

Consider another example in which the user agent determines that the user might desire to purchase a smartphone. The user agent locates smartphones for sale on the Internet, negotiates prices for various models of these smartphones, obtains service plan information for these smartphones, and obtains one or more customized advertisements for these smartphones. Icons for one or more of these advertisements are presented on a display of the user's HPED. The user activates an icon to watch a customized advertisement for one of the smartphones. After the customized advertisement plays, the user is presented with the price of the one smartphone and an Internet website where the user agent located this smartphone.

One or more different electronic devices, user agents, software applications, programs, and/or one or more different parties can customize the advertisement for the user. For example, a merchant can customize the advertisement for the user with information from the user profile of the user. As another example, a personal electronic device owned by the user (such as a smartphone, laptop, or tablet computer) can customize the advertisement for the user with information from the user profile of the user. As another example, an electronic device, program, and/or software application authorized by the user (such as a server computer or cloud server) can customize the advertisement for the user with information from the user profile of the user. As yet another example, a user agent authorized by the user can customize the advertisement.

Some examples of one or more electronic devices, software applications, programs, and/or user agents customizing the advertisement to include personal information (such as information from a user profile) of a user are provided below. These examples and/or aspects from these examples can be combined.

As one example, content in an advertisement is added, deleted, and/or changed to personalize the advertisement to a particular individual. For instance, video images and/or audio are added to the advertisement. The advertisement can be customized for a single user and then presented to that single user, as opposed to being created and then presented to a large group of users.

In an example embodiment, a single individual is the sole intended audience for the advertisement. Consider an example in which multiple users join a social network that displays advertisements to users. The social network displays an advertisement to each user for a tablet computer that is manufactured by company A. Each user sees a different variation of the advertisement for the tablet computer manufactured by company A. For example, the advertisement displayed to a first user includes images not present in the other advertisements displayed to the other users; the advertisement displayed to a second user includes images not present in the other advertisements displayed to the other users; the advertisement displayed to a third user . . . etc. The advertisement is modified to generate a number of unique advertisements that equal a number of users being shown the advertisement.

As an example, one or more images of a user are inserted into the customized advertisement displayed to this user. These images of the user customize the advertisement for the user since no two users have a same image. For instance, a body and/or face of the user are inserted into the advertisement to customize the advertisement to that particular user. Each advertisement is different since each user has a different facial image. A first user would see an advertisement with the first user appearing in the advertisement; a second user would see an advertisement with the second user appearing in the advertisement; a third user would see an advertisement . . . etc.

Users can be inserted into the advertisement as participants in the advertisement even though the user did not actually or physically participate in the filming of the template video. For example, the user can appear as an actor in the advertisement or as a bystander in the advertisement even though the user was not an actor in the advertisement (i.e., images of the user were edited into the video after the video was filmed or generated). For instance, the user interacts with the product and/or service being advertised, such as the user driving the advertised car, wearing the advertised clothes, eating the advertised food, being at the advertised location, and/or using or being associated with the advertised product.

Consider an example in which the advertised product is for an automobile. The customized advertisement includes the user driving the advertised automobile. The user would thus see himself or herself driving the advertised automobile in the advertisement that is directed to selling the automobile to the user. This example advertisement would assist the user in visualizing the experience of the user driving the automobile. The user could see what he or she would look like driving this automobile if the user were to purchase this automobile. The user, however, is not required to actually drive the automobile in order to generate the customized footage since the advertisement can be edited to include images of the user driving the automobile. The user can thus see what he or she would look like if the user were to purchase and use the product before the user actually purchases or uses the product.

As another example, information, objects, and/or user preferences from the user profile are inserted into the advertisement in order to customize the advertisement to the particular user. For example, the advertisement can be edited to include an animal or pet that the user owns, pictures that the user took, possessions of the user, and/or acquaintances or family of the user.

Consider an example in which the advertised product is for pet food, such as dog or cat food. The customized advertisement includes images of user's pet to customized the advertisement to the user. Consider another example in which the advertised product is for a computer. The customized advertisement includes images of family and/or friends of the user using the computer.

As another example, celebrities are inserted into the advertisement in order to customize the advertisement to the particular user. The celebrity can perform various actions to customize the advertisement to the user, such as speaking to the user, acknowledging the user, mentioning the name of the user, being displayed in an environment particular to the user, and/or holding and/or interacting with an object that the user owns. For example, the customize advertisement is a video that shows the user meeting and interacting with the celebrity and the product even though the user did not actually meet or interact with the celebrity and/or the product featured in the customized advertisement.

As another example, the user is inserted into video footage of a feature length movie. Consider an advertisement for a feature length movie in which the user is inserted into a trailer for the feature length movie. This trailer, which includes the user, is provided to the user to entice the user to see the movie.

As another example, scenery in the advertisement includes locations from a user profile. The locations include places where the user previously visited, a place where the user is currently located, and/or places where the user has not visited. Advertisements can thus be customized based on a present geographical location of the user, a previous or past geographical location of the user, and/or a future geographical location of the user.

Consider an example in which the advertisement depicts the user in Paris, France, but the user has not previously visited Paris. Consider another example in which the user is currently located near a restaurant. The advertisement shows the user going to or eating at this restaurant. This advertisement would assist in persuading the user to go and eat at this restaurant even though the user is not currently in the restaurant.

As another example, objects, locations, and/or products displayed in the advertisement are customized to match preferences in the user profile of the user. For example, preferences in the user profile indicate that the user prefers certain colors, shapes, sizes, geographical locations, etc. For instance, if the user prefers the color blue, mountains, and the outdoors, then an advertisement for an automobile is customized to show a blue automobile in a mountainous environment. If the preferences indicate that the user prefers surfing and sandy beaches, then the advertisement is customized to include these images.

As another example, the product featured in the video and/or the product being sold is edited to include the preferences of the user. For example, if the user prefers the color red and the product is for an automobile, then the color of the automobile being featured in the customized advertisement is changed to red in order to match the preferred color of the user.

As another example, products and/or services are placed in the advertisement based on the user profile. Even though the advertisement may not be for these products and/or services, they are placed in the advertisement to customize it to the user. Objects in the advertisement and/or the location of the advertisement are thus changed to match preferences in the user profile to assist in customizing the advertisement to the user.

Consider an example in which the user profile indicates that the user prefers talking on smart phone X and eating Italian food at restaurant Y. An advertisement for an automobile is customized to show an actor that has smart phone X and drives to eat Italian food at restaurant Y. The advertisement for the automobile is thus customized to include objects and/or locations that the user prefers.

Various methods can be used to customize an advertisement for multiple different users. For example, a stock or template video and/or advertisement is constructed, and then this stock or template video and/or advertisement is changed for each particular user in order to customize the advertisement for that particular user.

Consider an example in which a video advertisement is for an automobile. A template video is created in which an actor drives the automobile along a street and into a driveway of a residential house. The template video is created such that aspects of the advertisement can change after the video is filmed, such as the color of the automobile, the person driving the automobile, and the residential house in which the automobile parks. These aspects are altered to include user preferences so a unique advertisement is generated and displayed to each user. For instance, the advertisement displayed to a first user includes the first user driving a red automobile (a favorite color of the first user) and then parking the red automobile in the driveway of a house the first user. This first user, however, did not actually drive the automobile but was edited into the video after the video was filmed. The advertisement displayed to a second user includes the second user driving a white automobile (a favorite color of the second user) and then parking the white automobile in the driveway of a house of the second user. This second user, however, did not actually drive the automobile but was edited into the video after the video was filmed. The advertisement displayed to a third user includes the third user driving . . . etc. Thus, each advertisement is customized to each particular user so each user is presented with a different advertisement for the same product.

Thus, the users themselves are not actually filmed in the video, but are edited into the video. The users may not even be aware that the video is being filmed or that they are being edited into the video for an advertisement that will be sent to them at a later time. Users, though, could consent to have their personal preferences and/or user profile being included into customized advertisements that will be displayed to them.

After the video is filmed or created, the video is altered to make numerous additional videos that are each unique for each user. The number of unique videos created can correspond to a number of different users and/or groups of users that will view the videos. For example, if the target audience for the advertisement includes fifty thousand different users and/or groups of users, then the template video is customized fifty thousand times to create fifty thousand unique videos (one unique video for each user and/or group of users). This number of customized videos could be less than fifty thousand if two or more users had the same customizations that resulted in the same videos. This number could also be less than fifty thousand if a single customized video was produced for a group of people. For example, the fifty thousand people are further divided into groups sharing common characteristics, and each group is then provided with a single advertisement. Here, a number of customized advertisements would equal the number of groups plus the number of customized advertisements made for individuals.

FIG. 5 is a method to adjust customization of advertisements to users in accordance with an example embodiment.

According to block 500, a customized advertisement is presented to a user. For example, the customized advertisement is displayed to the user on a display of an electronic device, stored in memory, and/or transmitted over a network to the user and/or an electronic device.

According to block 510, a user's response to the customized advertisement is obtained. After or while the user views the customized advertisement, the user provides a reaction to the advertisement, and this reaction provides an indication as to the effectiveness of the advertisement. By way of example, the user's response to the advertisement includes, but is not limited to, one of an emotion of the user (e.g., the user laughs, cries, frowns, provides a facial expression in reaction to viewing the advertisement, etc.), an utterance from the user (e.g., the user comments about the advertisement during or after viewing the advertisement), a number of times the user views the advertisement, whether the user watches the entire advertisement (e.g., the user may not like the advertisement and stop viewing the advertisement before it finishes playing), whether the user views the advertisement (e.g., the user does not like the product being advertised and decides to not even view the advertisement), input from the user (e.g., the user may provide input to the advertiser regarding whether the user liked or did not like the advertisement), whether the user transmitted the advertisement to other people (e.g., the user forwards a hyperlink to view the advertisement to family and friends), and/or whether the user positively responded to the advertisement (e.g., viewing the advertisement caused the user to click on a link, buy a product or service presented in the advertisement, request more information about a product or service presented in the advertisement).

According to block 520, customization of a subsequent advertisement is adjusted based on the user's response to the previous advertisement. Information obtained per block 510 is used to change how future advertisements are customized so such future advertisements are more effective in advertising products and/or services to the user. This adjustment includes determining a hierarchy for information in the personal preferences and the profile of the user. For example, the user may prefer the colors red, white, and blue, but may prefer blue over red and white and red over white (thus resulting in a favorite color hierarchy of blue first, red second, and white third). As another example, the user may prefer video advertisements having a central theme of comedy, action, and drama, but prefer comedies over action and drama and action over drama (thus resulting in a favorite video theme hierarchy of comedy first, action second, and drama third). Hierarchies can be applied to other information included in the user profile as well.

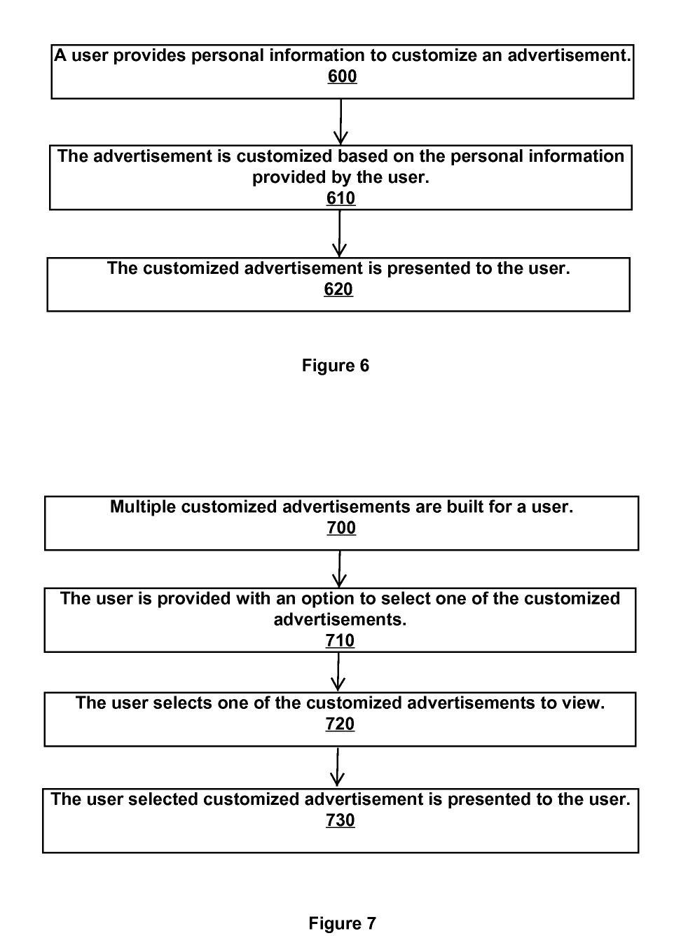

FIG. 6 is a method for a user to participate in building of a customized advertisement for the user in accordance with an example embodiment.

According to block 600, a user provides personal information to customize an advertisement. For example, an electronic device and/or user agent requests a user to provide personal information, such as personal preferences, that can be used to customize an advertisement. Alternatively, the user requests the electronic device to build a customize advertisement and also provides the electronic device with personal information that is included in the advertisement.

According to block 610, the advertisement is customized based on the personal information provided by the user. The personal information of the user is used to build the customized advertisement.

According to block 620, the customized advertisement is presented to the user. For example, the customized advertisement is displayed to the user on a display of an electronic device, stored in memory, and/or transmitted over a network to the user and/or an electronic device.

In an example embodiment, the user assists in building the customized advertisement before the advertisement is finished. An electronic device and/or user agent can query the user for personal information. For example, the electronic device asks the user if the user wants the advertisement to be in a particular geographical location, occur during the day or night, occur during a particular season of the year, occur for a particular product, etc.

In an example embodiment, the user requests the electronic device to build a customized advertisement that includes certain personal information. For example, the user considers purchasing a new mobile phone and requests an electronic device to provide an advertisement for the mobile phone. The user can also provide the electronic device with personal information that the user wants included in the advertisement. By way of illustration, the user asks for an advertisement for a specific mobile phone and wants this advertisement to include images or video of the user appearing with a celebrity and scenery from a particular geographical location, such as Hawaii (even though the user has never appeared with or met the celebrity and has not been to Hawaii).

A determination can also be made as to whether the user wants to pay a fee for certain products and/or services that will appear in the customized advertisement. For example, the user may be willing to pay money to have copyrighted or trademarked material appear in the customized advertisement. By way of illustration, the user wants the customized advertisement to include copyrighted footage from a Hollywood movie, a celebrity to appear in the customized advertisement, copyrighted music or songs, or use of a trademark of a company. Since the user does not own such material, the user pays a fee for the right to have such material appear in the customized advertisement.

FIG. 7 is a method to select a customized advertisement to display to a user in accordance with an example embodiment.

According to block 700, multiple customized advertisements are built for a user. These advertisements can be built for a single product and/or service, such as having multiple different customized advertisements for a particular model tablet computer. Alternatively, these advertisements can be built for different products and/or services, such as having one customized advertisement for a television, one customized advertisement for a cruise trip vacation package, and one customized advertisement for a motorcycle.

According to block 710, the user is provided with an option to select one of the customized advertisements. For example, a display presents the user with a short description (such as text, icons, graphics, links, thumbnails, etc.) of the different customized advertisements so the user can select which advertisement to view.

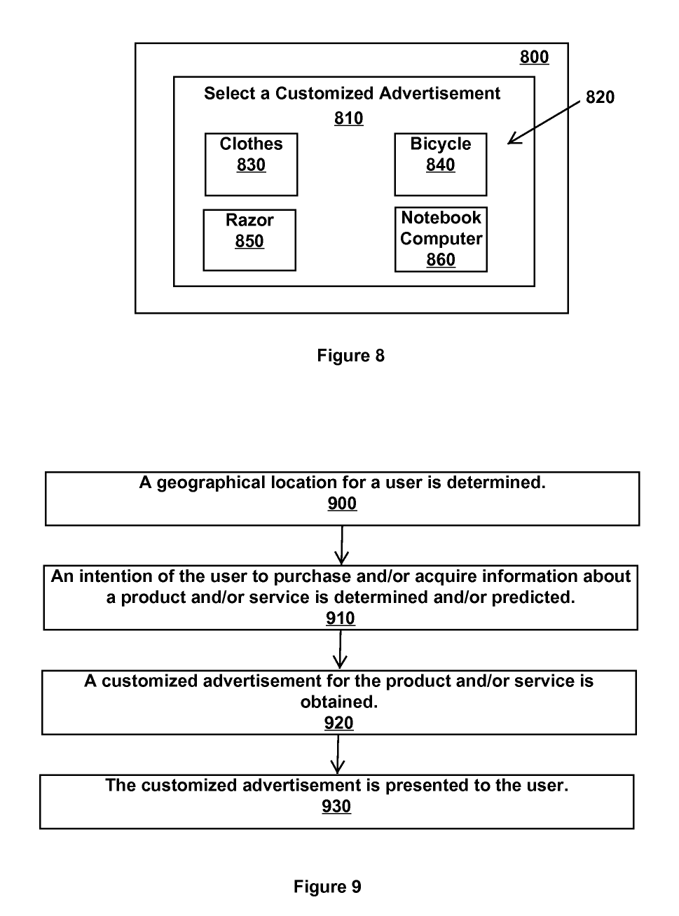

FIG. 8 shows an electronic device 800 with a screen 810 in accordance with an example embodiment. This screen 810 displays several different options 820 for a user to select a customized advertisement. For illustration purposes, these options are shown as clothes 830, a bicycle 840, a razor 850, and a notebook computer 860.

According to block 720, the user selects one of the customized advertisements to view. The user interacts with the electronic device 800 to select one of the customized advertisements being displayed. For example, the user clicks on one of the advertisements, highlights one of the advertisements, or provides a spoken or written command that indicates one of the customized advertisements.

According to block 730, the user selected customized advertisement is presented to the user. For example, the customized advertisement is displayed to the user on a display of an electronic device, stored in memory, and/or transmitted over a network to the user and/or an electronic device. For example, the user says the word “clothes” and this speech causes the electronic device to select the advertisement of clothes 830.

Alternatively, an electronic device and/or user agent selects one of the advertisements to display to the user. This selection can be based on personal information and/or user profile information. For example, the user profile includes an indication that the user desires or needs new clothes. Based on this information, the advertisement with clothes 830 is selected and played to the user on a display of an HPED.

FIG. 9 is a method to customize advertisements in accordance with an example embodiment.

According to block 900, a geographical location for a user is determined. The geographical location includes, but is not limited to, a current physical geographical location of a user, a previous physical geographical location of the user, and a predicted or future physical geographical location of the user. The geographical location of the user can be determined by determining a location of the user and/or determining a location of an electronic device associated with the user, such as an HPED that accompanies the user or that is proximate to the user.

In an example embodiment, an electronic device of a user assists in determining the geographical location. For example, the user carries or has an HPED or other electronic device that uses one or more of the following to track the electronic device and/or determine a geographical location of the user: global positioning system (GPS) tracking, communication with a space-based satellite, global system for mobile communication (GSM), general packet radio service (GPRS), geographic information system (GIS), communication with a cellular network, short-range wireless communications (such as infrared or Bluetooth), techniques utilizing multilateration (such as measuring distances to two or more stations over time), tracking of a handset and/or a subscriber identification module (SIM) card, communication with a wireless network (such as a wireless local area network (WLAN)), and/or radio frequency identification (RFID, such as using an RFID tag).

According to block 910, an intention of the user to purchase and/or acquire information about a product and/or service is determined and/or predicted. For example, a determination is made as to what the user intends to do or bring about with regard to a product and/or service. When a determination is made that the user intends (or is considering) to purchase or acquire more information about a product and/or service, then advertisements for the products and/or services are presented to the user, such as being displayed to the user on a display of an HPED.

In an example embodiment, when a determination is made that a user is intending or considering purchasing a product and/or service, then advertising for that product and/or service to the user commences at this time. Alternatively, at this time, the frequency or rate at which advertisements are presented to the user increases.

Consider an example in which a user decides to purchase a new tablet computer or acquire more information about tablet computers in order to make a decision whether or not to buy such a computer. At this time, the user may not have finalized a decision on which brand and model to purchase, especially since so many different brands and models exist. An advertisement for a tablet computer at this time would be welcome or influential since the user is considering, or already decided, to purchase a new tablet computer or acquire more information about such a computer. The effect of presenting the advertisement to the user at this time would have more impact than this advertisement being presented to the user when the user had no intention of purchasing a new tablet computer. Consumers that are prepared or considering to buy a product and/or service in a particular market category are more susceptible to advertisements than consumers that are complacent or have no interest in products and/or services in the market category.

Consider another example in which a user is interested in purchasing a smartphone. At this time, the user may not have decided which brand of smartphone to purchase. Even if the user has decided on a brand, the user may not have decided on which model to purchase or may not be aware of all available models. Further yet, even if the user has decided on a brand and model, the user may be persuaded to purchase a different brand and model. A customized advertisement for a smartphone is presented to the user at this time.

In an example embodiment, the determination of the intention of the user to purchase a product and/or service is made independent of or without regard to the geographical location of the user. As such, the determination of the intention of the user to purchase a product and/or service is not influenced by, dependent on, and/or contingent on the current, previous, or future geographical location. Alternatively, the geographical location of the user can be a factor in determining the intention of the user to purchase a product and/or service.

Example embodiments analyze a variety of different data to determine an intention of the user to purchase a product and/or service. These data include, but are not limited to, one or more of the following examples of personal information and/or information included in a user profile. As one example, written words (such as text in an email or short message service (SMS)) are analyzed to determine an intention of the user. For instance, a user might use keywords in an email stating an intention or consideration to buy a product. As another example, spoken words are analyzed to determine an intention of the user. For instance, during a telephone call, a smartphone of the user extracts keywords and determines that the user is considering purchasing a printer. An analysis of linguistic features can be used to determine an intention of a user. As another example, internet surfing and/or webpage visits are used to determine an intention of the user. Internet browsing and sequence of actions performed while browsing also provide information that can be used in intention modeling for a user. For instance, the user researches on the internet information about different types of digital cameras and visits websites that discuss and/or sell digital cameras. The user may look at images of cameras and investigate price ranges or costs for cameras. Actions such as clicking a hyperlink, performing a query, saving a webpage, and/or closing a browser window can also provide information regarding user intent. As another example, a calendar application can include information. For instance, an online or computer calendar of the user can include notes to take an action on a certain date (such as “buy bicycle for daughter's birthday”). As another example, historical or previous purchases are used to determine an intention of a user. For instance, a user may have a pattern of purchasing a new pair of tennis shoes every 10 to 12 months. This pattern of purchasing provides a time frame or window of time when the user will purchase the next pair of tennis shoes. Consider another instance in which a user habitually purchased action movies once they are released on digital video disk (DVD). This repeated action of purchasing action movies provides an indication that the user will purchase an action movie being released on DVD. As another example, the previous purchase of durable and/or non-durable goods are used to determine an intention of a user. For instance, the user may purchase perishable goods with a known shelf life. The expiration of this shelf life can provide an indication when the user will intend to purchase the perishable goods again. As another example, a time of year is used to determine an intention of a user. For instance, the user may purchase gifts or decorations for certain holidays. As another instance, the user may travel on vacation during a given time period each year (such as the user taking a vacation each year during the first two weeks of August). As another example, demographics of a user (such as age, gender, race, ethnicity, mobility, home ownership, marital status, employment status, disabilities, income level, etc.) are used to determine an intention of a user.

The determination to purchase a product and/or service can be modeled as a prediction that the user will purchase a product and/or service. For example, an analysis of the personal information and/or user profile provides a probability and/or likelihood that the user will make a purchase of the product and/or service (such as a probability that the user intends to purchase a product within a product category). By way of example, one or more predictive models are used to predict the probability that a user or consumer determines to purchase a product and/or service. This probability is based on one or more of the geographical location, personal information, user profile, and the other data discussed herein. The predictive models can use one or more classifiers to determine this probability. Example models and/or classifiers include, but are not limited to, a Naive Bayes classifier (including classifiers that apply Bayes' theorem), k-nearest neighbor algorithm (k-NN, including classifying objects based on a closeness to training examples in feature space), statistics (including the collection, organization, and analysis of data), support vector machine (SVM, including supervised learning models that analyze data and recognize patterns in data), data mining (including discovery of patterns in datasets), artificial intelligence (including systems that use intelligent agents to perceive environments and take action based on the perceptions), machine learning (including systems that learn from data), pattern recognition (including classification, regression, sequence labeling, speech tagging, and parsing), knowledge discovery (including the creation and analysis of data from databases and unstructured data sources), logistic regression (including generation of predictions using continuous and/or discrete variables), group method of data handling (GMDH, including inductive algorithms that model multi-parameter data) and uplift modeling (including analyzing and modeling changes in probability due to an action, such as an action on a consumer).

Additionally, the intention, prediction, or determination to purchase a product and/or service can occur along different stages of the consumer decision-making process (such as problem recognition, information search, information evaluation, and purchase decision). During problem recognition, the consumer recognizes a need or a want and associates a product and/or service with this need or want. Problem recognition can also occur when a consumer discovers new information about a product, business, service, etc. During information research, the consumer searches or receives information that will assist the consumer in making a decision on which product and/or service to purchase. During information evaluation, the consumer evaluates and compares features and attributes of the different products and/or services. For instance, the consumer can compare prices, sizes, colors, brands, availability, service, etc. During purchase decision, the consumer makes a purchase decision and buys the product and/or service.

According to block 920, a customized advertisement for the product and/or service is obtained. For example, once an intended product and/or service is determined, then a customized advertisement for this product and/or service is built, retrieved, received, and/or obtained by an electronic device. For instance, if a determination is made that the intention of the user is to purchase a refrigerator or acquire more information about a refrigerator in order to make an informed decision whether or not to purchase the refrigerator, then a customization advertisement for a refrigerator is presented to the user.

According to block 930, the customized advertisement is presented to the user. For example, the selected advertisement is displayed to the user on a display of an electronic device, stored in memory, and/or transmitted over a network to the user and/or an electronic device.

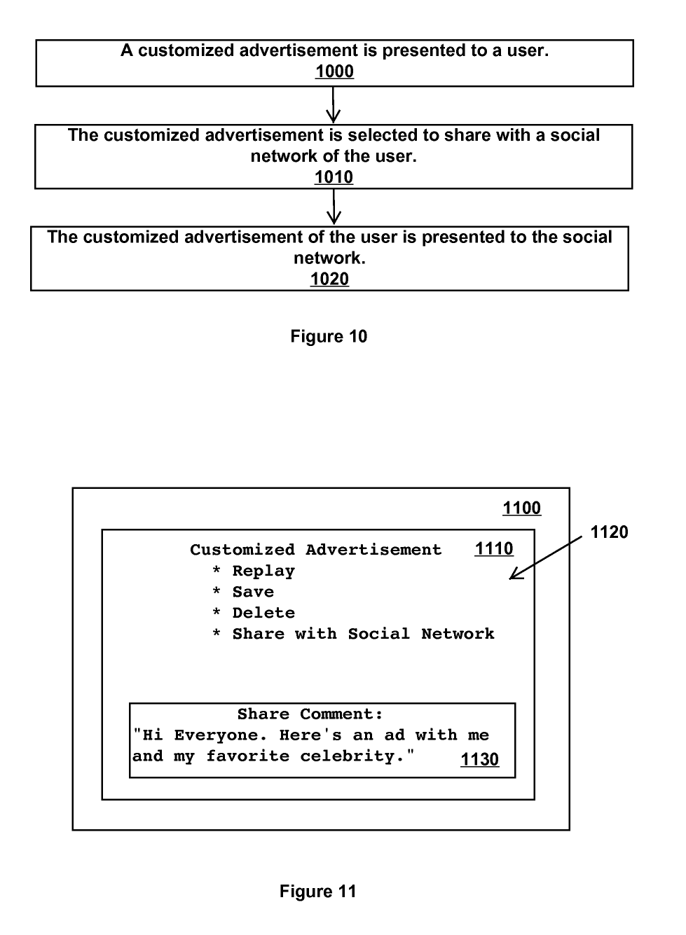

FIG. 10 is a method to share customized advertisements with a social network in accordance with an example embodiment.

According to block 1000, a customized advertisement is presented to a user. For example, the selected advertisement is displayed to the user on a display of an electronic device, stored in memory, and/or transmitted over a network to the user and/or an electronic device.

According to block 1010, the customized advertisement is selected to share with a social network of a user. For example, the customized advertisement for the user is provided to a social network to which the user belongs.

FIG. 11 is an electronic device 1100 with a display screen 1110 that displays options 1120 with regard to a customized advertisement in accordance with an example embodiment. By way of example, these options 1120 include, but are not limited to, one or more of replaying the customized advertisement to the user, saving the customized advertisement to an electronic device, deleting the customized advertisement, and/or sharing the customized advertisement with a social network. The display screen 1110 also includes an area 1130 that receives input information from the user. For example, the area 1130 includes a text box, text field, or text entry box that receives input text from a user. By way of illustration, the area 1130 shows a user entry providing a comment: “Here is a commercial featuring me with my favorite celebrity.” The user enters this comment into a multiline text box.

According to block 1020, the customized advertisement of the user is presented to the social network. For example, the customized advertisement is displayed on electronic devices to other users of the social network, stored in memory, and/or transmitted over one or more networks to the other users and/or electronic devices. For instance, the user belongs to a social network and has members or friends that also belong to the social network. These member or friends of the user are presented with the customized advertisement of the user so the members or friends can play and view the customized advertisement.

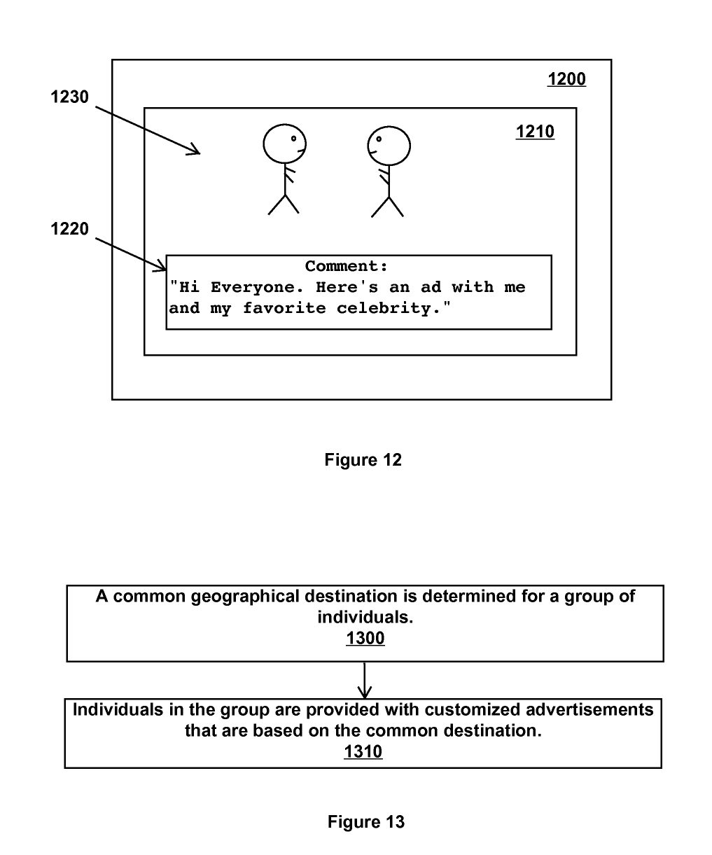

FIG. 12 is an electronic device 1200 with a display screen 1210 that displays information 1220 and a customized advertisement 1230 in accordance with an example embodiment. By way of illustration, the information 1220 is a comment (i.e., “Here is a commercial featuring me with my favorite celebrity.”) that the user entered. The comment is a message to the viewers of the customized advertisement.

Consider an example in which a customized advertisement is built for and presented to a user. This advertisement is a video commercial for a smartphone in which the user appears talking to a celebrity using the smartphone. After viewing the customized advertisement for the smartphone, the user decides to share the advertisement with family and friends that belong to a social network to which the user also belongs. After the customized advertisement plays on a display screen, the user has the option to forward or send the customized advertisement to the family and friends. For instance, display screen 1210 of FIG. 12 appears on the electronic device of the user. The user selects the option “Share with a social network” and the advertisement is presented to the user's family and friends that belong to the selected social network. These family and friends can play and view the commercial featuring the user and the celebrity. By way of example, the commercial can be provided to the family and friends (i.e., the users) by one or more of emailing the commercial, providing a hyperlink to the commercial, posting an announcement to view the commercial, automatically displaying the commercial (e.g., display the commercial to the users when they access the social network), displaying the commercial on the electronic devices of the users, providing an icon to the users to watch the commercial, automatically playing the commercial on electronic devices of the users, etc.

FIG. 13 is a method to provide customized advertisements to a group of people with a common geographical destination in accordance with an example embodiment.

According to block 1300, a common geographical destination is determined for a group of individuals. A geographical destination (i.e., a point or an area on the surface of the earth) for one or more persons in the group can be determined in order to determine the destination for the group and/or individuals in the group.

As an example, if the group has three individuals, then a destination for each individual is determined. Consider an example in which the three individuals are traveling in a vehicle that is driving from Los Angeles toward Los Vegas. Each individual has provided information with an electronic device indicating an intention to travel to Los Vegas. By way of further illustration, this information could be determined and/or extracted from hotel or flight reservations, emails, texts, phone calls, GPS tracking, electronic calendars, or input into an electronic device.

As another example, a destination for a single person in the group can be determined, and this destination is attributed to other individuals in the group. Consider an example in which a group of individuals are walking outdoors. An individual in the group uses a mapping location or map finder application on his smartphone to get directions to a nearby shopping plaza that the group is walking toward. This destination of the shopping plaza can be inferred for the individual and other individuals in the group.

As another example, a destination for a group can be determined from a vehicle or transportation device. Consider an example of an airplane, bus, or train that is scheduled to go from Houston to New Orleans. Individuals boarding this airplane, bus, or train in Houston will be arriving in New Orleans. Flight times, bus numbers, routes, schedules, etc. are electronically available over a network, such as the Internet.

According to block 1310, individuals in the group are provided with customized advertisements that are based on the common destination. A single customized advertisement is provided to individuals in the group. Alternatively, each individual in the group is provided with a unique, different customized advertisement for a same product and/or service.

Consider an example in which a group of people is traveling in a van that is going to eateries located on a wharf. Customized advertisements for restaurants at the wharf are simultaneously provided to one or more of the individuals in the group while they are traveling in the van to the wharf. Each individual in the group can receive a customized advertisement for the same restaurant. Alternatively, a single customized advertisement is presented to each member of the group. This customized advertisement can be based on personal information and/or user profiles from each of the individuals in the group. For example, personal preferences from each of the individuals are analyzed to determine common preferences. For instance, a majority of the individuals in the group prefer beach scenery and surfing, so the advertisement is customized to include a beach and surfing.

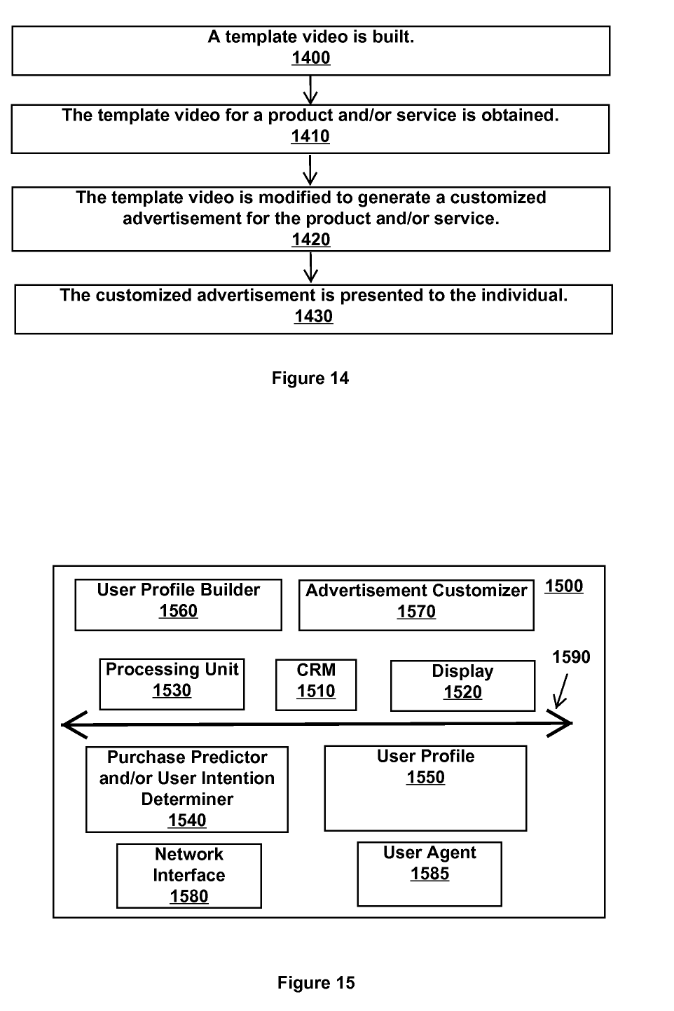

FIG. 14 is a method to generate a customized advertisement from a template video in accordance with an example embodiment.

According to block 1400, a template video is built. The template video is built from a method that includes, but is not limited to, one or more of the following: chroma key compositing or chroma keying (e.g., layering images and/or video based on color hues, such as green screen chroma keying or blue screen chroma keying), computer-generated imagery (CGI), traveling mattes, rotoscoping, multiple motion control passes (such as motion control photography) digital image masking, matte paintings, photographs, video footage, filming video, taking photographs, and intercutting with B-roll footage, stock footage, archive footage, library pictures and/or file footage.

According to block 1410, a template video for a product and/or service is obtained. One or more template videos are built and then stored in electronic memory, such as a database, library, computer memory, read-only memory, volatile memory, non-volatile memory, computer data storage, semiconductor memory, etc. For example, a template video is obtained for a product and/or service that a user wants, desires, intends to purchase, etc.

According to block 1420, the template video is modified to generate a customized advertisement for the product and/or service. One or more images (such as video, objects, scenes, and/or photographs) in the template video are changed to make a customized advertisement that is unique for an individual or a group of people. For example, the template video is edited to include personal information, such as information from a user profile of a user.

By way of example, the video template can be modified using one or more of software and/or applications that perform digital motion graphics and image compositing, perform after effects on video, create motion graphics and/or visual effects, edit animation, use plug-ins to generate effects (e.g., rain, snow, fire, wind, etc.), perform video editing, perform 2D and/or 3D compositing for visual effects, and/or perform titling.

According to block 1430, the customized advertisement is presented to the individual. For example, the customized advertisement is displayed on electronic devices to the user, stored in memory, and/or transmitted over one or more networks to the users and/or an electronic device.

Consider an example in which a determination is made that a user might purchase a watch or would like to own a watch. After making this determination, a template video in the form of an advertisement for a watch is retrieved. This template video, for instance, may be available from a company that manufactures or sells watches. The template video is then modified with personal information that is unique to the user. This information can be retrieved from the profile of the user. For instance, facial images and/or facial video of the user are inserted or edited into the template video so the user appears in the template video (e.g., the facial images of the user are placed over green or blue screen footage and/or CGI is used to edit the user into the video). The template video, now a customized advertisement, is displayed to the user on an HPED of the user. The user thus appears to be a participant or actor in the advertisement even though the user did not actually or physically appear at the location of the video. In other words, the user was not involved in the acting, making, filming and/or editing of the customized advertisement.

Consider another example in which the user with his handheld electronic device is walking along a boardwalk that has various retail stores. A location of the user and/or the electronic device is tracked. The user enters a retail store that sells televisions. This action provides a determination that the user is likely interested in purchasing a television or likely interested in getting more information about a television (such as getting product information for the televisions, viewing the televisions, determining prices for the televisions, etc.). After making this determination, one or more template videos in the form of advertisements for one or more of the televisions in the store are retrieved, such as being retrieved from memory. Information particular to the user is also retrieved, such as information in the user's profile. This information indicates that the user prefers the color blue, beaches, and tropical weather. Based on this information, a template video is selected that matches this information. The selected template video is then edited to include information particular to the user. In other words, the template video is tailored or custom-made to qualities of the user (such as interests, tastes, habits, preferences, etc.) in order to produce a unique customized advertisement for the television. The template video, now a customized advertisement, is displayed to the user on the handheld portable electronic device of the user. For instance, the advertisement shows the user relaxing in a beach house on a sunny day while watching television from one of the televisions for sale in the retail store.

The customized advertisements are built, edited, and/or generated quickly since the template videos already exist (e.g., the template video is retrieved from an electronic device, data storage, a server, memory, or a network cloud location). The template videos can be modified in real-time and presented to the user almost instantaneously and/or immediately after making the determination of which product and/or service to advertise to the user (e.g., immediately after making a determination of the product the user intends to purchase and/or receive information). The time to retrieve the template video and modify it to a customized advertisement would depend on various factors, such as the length of the video, size of the video, processing power to edit the video, amount of video being edited, amount of memory being used, amount of personalized information being edited into the video, etc. By way of example, this time could vary from a few seconds to a few minutes or more.

By way of example, the customized video can be presented to the user in real-time while the user is viewing a desired product and/or service. Consider the example in which the user is walking along the boardwalk and enters the retail store that sells televisions. As the user enters the store (or stops in front of the store or enters a vicinity of the store), the template video for a television and user profile information are retrieved. The template video is immediately modified or edited to include user profile information to generate the customized advertisement. This advertisement is presented to the user shortly after the user walks into the retail store. For instance, the user's handheld electronic device rings or vibrates (or otherwise notifies the user) to indicate that the user has an advertisement. The user views the display of the handheld electronic device, and the customized advertisement for the television begins to play on the display. By way of example, this customized commercial for the television could be presented and/or played to the user while the user enters the stores, stands near the store, walks within the store, and/or remains in the store.

Retrieval and modification of the template videos can also be based on a geographical location of the user. Consider an example in which the user walks to a road intersection. Retail stores in a first direction of the road specialize in electronics, while retail stores in a second, opposite direction of the road specialize in selling clothes. When the user begins to walk in the first direction, then template videos are retrieved for the electronics. If the user were to change directions and proceed in the second direction, then template videos are retrieved for the clothes. As such, customized advertisements being presented to the user change in real-time as the geographical position of the user changes.

FIG. 15 is an electronic device 1500 in accordance with an example embodiment. The electronic device includes components of computer readable medium (CRM) or memory 1510, a display 1520, a processing unit 1530, a purchase predictor and/or user intention determiner 1540, a user profile 1550, a user profile builder 1560, an advertisement customizer 1570, a network interface 1580, a user agent 1585, and one or more buses or communication paths 1590. FIG. 15 shows these components in a single electronic device. Alternatively, one or more of these components can be distributed or included in various electronic devices, such as some components being included in an HPED, some components being included in a server, some components being included in storage accessible over the Internet, etc.

By way of example, the purchase predictor and/or user intention determiner 1540 can perform functions such as those described in connection with FIGS. 2 and 9. The user profile builder 1560 can perform functions such as those described in connection with FIG. 2. The advertisement customizer 1570 can perform functions such as those described in connection with FIGS. 4, 5, 6, 9, and 14.

The processor unit 1530 includes a processor (such as a central processing unit, CPU, microprocessor, application-specific integrated circuit (ASIC), etc.) for controlling the overall operation of memory 1510 (such as random access memory (RAM) for temporary data storage, read only memory (ROM) for permanent data storage, and firmware). The processing unit 1530 communicates with memory 1510 and performs operations and tasks that implement one or more blocks of the flow diagrams discussed herein. The memory 1510, for example, stores applications, data, programs, algorithms (including software to implement or assist in implementing example embodiments) and other data. The network interface 1580 provides a mechanism for the electrical device 1500 to communicate with other electrical devices, computers, or systems. For example, the network interface 1580 enables the electrical device to transmit data through a wired or wireless connection to a network, such as the Internet and/or a cellular network.

As used herein, the term “advertisement” is an announcement or public notice for the rent or sale of a product and/or service.

As used herein, a “celebrity” is a person who has a prominent public profile and is recognized by the general public. Celebrities often have frame, fortune, and/or prominence in a particular field, such as the field of professional sports, entertainment (e.g., movie and/or television actors), or music (e.g. musicians in a popular band).

As used herein, a “customer” is person that is a recipient or a potential recipient of a good, service, product, and/or idea from a seller, vendor, and/or supplier for a monetary or other valuable consideration. For example, company A launches an advertisement campaign to inform the public (i.e., customers) about a new product.

As used herein, the term “customize” means to build or alter to individual or personal specifications.

As used herein, the term “customized advertisement” is an announcement or public notice for the rent or sale of a product and/or service that has been built or altered to individual or personal specifications. For example, a customized advertisement for an individual includes information pertaining to specific characteristics and/or preferences of the individual. These characteristics and/or preferences can be unique to the individual, such as information obtained from a user profile of the individual.

As used herein, the term “intention” means what one intends to do or bring about. For example, a user decides to purchase a new television or obtain information about the new television (e.g., determine a cost for the new television or see the new television). The user gets into an automobile and drives to a retail store with the intention of purchasing the new television or with the intention of obtaining information about the new television.

As used herein, a “merchant” is an operator of a business that sells or rents a product and/or service. Merchants include operators that produce the product and/or service, sell the product and/or service to consumers (i.e., retail merchant), and/or operate between the retail merchant and the producer of the product and/or service (wholesale merchant).

As used herein, a “social network” is a social structure in which users communicate with each other over a network with electronic devices. The social network facilitates the building of social relations among users who share backgrounds, familial relations, business relations, interests, and/or connections. The social network includes one or more of representations and/or information about the users (such as user profiles, photos, videos, etc.) and a platform (such as a web-based platform) that allows the users to communicate with each other over one or more network (such as using email and/or instant messages over the Internet) and/or share information with other users in the social network.

As used herein, a “template” is a pattern that serves as a guide to produce other things. For example, a template video is video footage, photographs, scenes, and/or images that serve as a pattern to generate other videos, photographs, scenes, and/or images, such as advertisements and/or commercials. For example, the template video can be edited to add additional video footage, delete existing video footage in the template, and/or change existing video footage in the template.

As used herein, a “user” is a human being, a person.

As used herein, a “user agent” is software that acts on behalf of a user. User agents include, but are not limited to, one or more of intelligent agents (agents that use learning, reasoning and/or artificial intelligence), multi-agent systems (plural agents that communicate with each other), mobile agents (agents that move execution to different processors), autonomous agents (agents that modify processes to achieve an objective), and distributed agents (agents that execute on physically distinct electronic devices).

As used herein, a “user profile” is personal data that represents an identity of a specific person or organization. The user profile includes information pertaining to the characteristics and/or preferences of the user. Examples of this information for a person include, but are not limited to, one or more of personal data of the user (such as age, gender, race, ethnicity, religion, hobbies, interests, income, employment, education, etc.), photographs (such as photos of the user, family, friends, and/or colleagues), videos (such as videos of the user, family, friends, and/or colleagues), and user-specific data that defines the user's interaction with and/or content on an electronic device (such as display settings, application settings, network settings, stored files, downloads/uploads, browser activity, software applications, and/or privileges).

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

Method blocks discussed herein can be automated and executed by a computer or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

What is claimed is:

1. A method executed by a computer system, comprising:
determining, by the computer system and based on information in a user profile of a user, a product that the user expressed an interest in purchasing;
obtaining, by the computer system, a template video that is an advertisement for the product that the user expressed the interest in purchasing;
negotiating, by the computer system and with a merchant that sells the product, a price for the product;
modifying, by the computer system, the template video to include personal information about the user to generate a customized advertisement that is unique to the user; and
presenting the customized advertisement and the price to the user.

2. The method of claim 1 further comprising:
modifying the template video in real-time so the customized advertisement is presented to the user immediately after making a determination of the product that the user expressed the interest in purchasing.

3. The method of claim 1 further comprising:
inserting facial images of the user into the template video in order to generate the customized advertisement that is unique to the user.

4. The method of claim 1, wherein the determining the product that the user expressed the interest in purchasing is based on both keywords extracted from information entered by the user into an handheld portable electronic device (HPED) and a geographical location of the user.

5. The method of claim 1 wherein the negotiating the price for the product further comprising:
determining an offering price for the product from a merchant; and
presenting a counteroffer to the merchant to the offering price for the product before modifying the template video to include the personal information.

6. The method of claim 1 further comprising:
modifying the template video to include personal preferences of the user that include changing a color of the product shown in the customized advertisement to match a preferred color of the user.

7. The method of claim 1 further comprising:
receiving input from the user to share the customized advertisement with friends that belong to a social network to which the user also belongs; and
presenting the customized advertisement to the social network so the customized advertisement displays on electronic devices of the friends of the user.

8. A computer system, comprising:
a memory that stores instructions; and
a processing unit that executes the instructions to:
analyze personal information of a user to predict a product that the user has an interest to purchase,
negotiate with a merchant for a price of the product,
obtain a template video that is an advertisement for the product, the template video being edited to generate a customized advertisement that includes both the price and video footage unique to the user, and
present the customized advertisement to the user.

9. The electronic device of claim 8, wherein the processing unit further executes the instructions to:
retrieve a first template video based on the user walking a first direction toward a first store, and
retrieve a second template video based on the user walking in a second direction toward a second store.

10. The electronic device of claim 8, wherein the processing unit further executes the instructions to:
determine a common geographical destination for a group of individuals that include the user, and
provide different customized advertisements for a same product to each of the individuals in the group based on the common destination.

11. The electronic device of claim 8, wherein video images of the user are edited into the template video so the user appears to be an actor in the customized advertisement even though the user did not actually participate in filming of the template video.

12. The electronic device of claim 8, wherein the processing unit further executes the instructions to:
negotiate the price for the product without the user having knowledge of negotiations since the computer system is authorized to negotiate the price on behalf of the user, and
present the negotiated price in the customized advertisement while the customized advertisement plays to the user.

13. The electronic device of claim 8, wherein the processing unit further executes the instructions to:
modify the template video to generate a number of unique advertisements, wherein the number of unique advertisements being generated equals a number of users being shown the advertisement for the product.

14. The electronic device of claim 8, wherein the template video is edited to include the user interacting with the product and include a celebrity featured in the customized advertisement even though the user did not actually interact with the celebrity and the product.

15. A non-transitory computer readable storage medium storing instructions for causing a computing system to execute a method, comprising:
examine personal information of a user to determine a product about which the user is interested in receiving information;
negotiate, with a merchant selling the product, for a price of the product;
retrieve from memory a template video that is an advertisement for the product;
edit the template video to include personal preferences of the user to generate a customized advertisement that is intended to be viewed solely by the user; and
present the customized advertisement and the price to the user.

16. The non-transitory computer readable storage medium storing instructions of claim 15 further causing the computer system to execute the method comprising:
retrieve and modify the template video to generate the customized advertisement while the user is located in a store that sells the product; and
present the customized advertisement to the user while the user is located in the store.

17. The non-transitory computer readable storage medium storing instructions of claim 15 further causing the computer system to execute the method comprising:
edit the user into the customized advertisement so the user can see what the user would look like using the product before the user actually purchases the product and before the user actually uses the product.

18. The non-transitory computer readable storage medium storing instructions of claim 15 further causing the computer system to execute the method comprising:
obtain a plurality of different advertisements for the product; and
compare information in a user profile of the user to the plurality of different advertisements to select which one of the advertisements the user prefers to view.

19. The non-transitory computer readable storage medium storing instructions of claim 15 further causing the computer system to execute the method comprising:
present the user with the price of the product as part of the customized advertisement such that customized advertisement reveals the price to the user while the customized advertisement plays to the user.

20. The non-transitory computer readable storage medium storing instructions of claim 15 further causing the computer system to execute the method comprising:
insert a facial image of user into the template video in order to generate the customized advertisement that shows the user as an actor in the customized advertisement even though the user never physically appeared as an actor to make the template video.
